(19) United States
(12) Patent Application Publication
(10) Pub. No.: US 2006/0176453 A1
(43) Pub. Date: Aug. 10, 2006

(54) Projector

(75) Inventor: Masatake Miyamoto, Osaka (JP)

Correspondence Address: OSHA LIANG L.L.P., 1221 MCKINNEY STREET, SUITE 2800, HOUSTON, TX, 77010, US

(73) Assignee: Funai Electric Co., Ltd., Osaka (JP)

(21) Appl. No.: 11/267,048

(22) Filed: Nov. 4, 2005

(30) Foreign Application Priority Data
Nov. 4, 2004 (JP) P2004-321056

(51) Int. Cl. G03B 21/14

(52) U.S. Cl. 353/119

(57) ABSTRACT

A projector includes a light source lamp, a projection lens for projecting an image, a light modulation element for reflecting and providing light radiated from the light source lamp to the projection lens, a printed wiring board for controlling the light modulation element attached to the printed wiring board, an optical part holder for mounting the projection lens and the light modulation element. The printed wiring board is mounted to the optical part holder by at least four screw members which are arranged so as to surround the light modulation element. The screw member is attached to the optical part holder through a compression coil spring which is arranged between the printed wiring board and the optical part holder. The light modulation element is position controlled by adjusting an amount of turning of the screw member.

### BACKGROUND OF THE INVENTION

1. Field of the Invention

The present invention relates to a projector and, more particularly, to a projector having a light modulation element.

2. Description of the Related Art

Conventionally, various projectors have been proposed which are equipped with a light modulation element such as a DMD (digital micromirror device) or a liquid crystal panel and have an angle adjusting function (refer to JP-A-2004-45733 and JP-A-11-202408, for example).

JP-A-2004-45733 discloses the configuration of a projection display device in which the angle of a DMD can be adjusted by rotating an adjustment dial which is exposed to the outside from a case and thereby rotating a DMD driving circuit board (printed wiring board) which is attached to a gear that is supported rotatably by a pivotally supporting means which moves in link with the adjustment dial.

JP-A-11-202408 discloses the configuration of a projector in which the optical axes can be/adjusted for light beams that are guided from liquid crystal panels (light modulation elements) to a combining prism by rotating plate-like transparent members disposed between the liquid crystal panels and the combining prism in accordance with amounts of turning of screws (screw members).

Another projector is known which is equipped with a mirror for reflecting light emitting from a light source light and thereby guiding it to a light modulation element such as a DMD (refer to Japanese Utility Model Registration No. 3,092,508, for example). Japanese Utility Model Registration No. 3,092,508 discloses the configuration of a projector in which the angle of a mirror is adjusted by adjusting the amounts of turning of mirror adjustment screws (screw members) in a structure in which the mirror for reflecting light emitted from a light source light and thereby guiding it to a DMD mounted on a body is mounted on the body by the mirror adjustment screws.

Still another projector is known which employs a DMD as a light modulation element. The DMD is equipped with a large number of mirrors on its surface. The large number of mirrors are displaced according to an image signal and an image is formed by presence/absence of reflection light. To form a good image, it is necessary to accurately position the DMD which reflects light radiated from a light source lamp and thereby supplies it to a projection lens. FIG. 16 is a perspective view showing the entire configuration of one conventional projector. FIG. 17 is a plan view of the one conventional projector of FIG. 16. FIGS. 18 to 20 are for description of detailed structures of the one conventional projector. The configuration of the one conventional projector will be described with reference to FIGS. 16 to 20.

As shown in FIG. 16, the one conventional projector is equipped with a lower case 101, a front case 102, and a rear case 103. A side wall of the lower case 101 is formed with air inlets 101a through which to take in air. The front case 102 and the rear case 103 are attached to the lower case 101. As shown in FIGS. 16 and 17, the front case 102 is formed with air inlets 102a through which to take in air and air outlets 102b through which to discharge air.

A lamp case holder 104 is disposed in the lower case 101 near the front case 102. As shown in FIG. 17, a lamp case 106 which is mounted with a light source lamp 105 is housed in the lamp case holder 104. The light source lamp 105 has a light source 105a for emitting light and a reflector 105b for reflecting and thereby focusing the light emitted from the light source 105a. As shown in FIGS. 16 and 17, a temperature control fan 107 for controlling the temperature of the light source lamp 105 by guiding a wind to the light source lamp 105 at a prescribed rate is disposed beside the lamp case holder 104 and the lamp case 106 mounted with the light source lamp 105.

A metal casting 108 having a lens mounting portion 108a is disposed in the lower case 101. A projection lens 109 for projecting an image is mounted on the lens mounting portion 108a of the casting 108. As shown in FIG. 19, an opening 108b is formed in the casting 108 at such a position as to be opposed to the lens mounting portion 108a. The casting 108 is formed with a projection 108c in such a manner that it surrounds the opening 108b. The projection 108c has, near its four corners, respective bosses 108d which are formed with respective threaded holes 108e. As shown in FIG. 17, a light tunnel 110 for shaping light into a rectangular shape is attached to the casting 108 at a position where light radiated from the light source 105a of the light source lamp 105 is focused. The light tunnel 110 is fixed to the casting 108 by means of a light tunnel clip 111. The light tunnel 110 has an entrance portion 110a at which light coming from the light source lamp 105 enters the light tunnel 110 and an exit portion 110b at which the light exits from the light tunnel 110, and the light tunnel 110 assumes a pipe-like shape having four walls. A transmission member 112 for transmitting light that has been shaped by the light tunnel 110 is attached to the casting 108 on the exit portion 110b side of the light tunnel 110. A cooling fan 113 is disposed beside the light tunnel 110 and the transmission member 112 so as to be juxtaposed with the temperature control fan 107. The cooling fan 113 is provided to cool the casting 108 and optical parts such as the light tunnel 110 by taking in air through the air inlets 102a of the front case 102 and guiding a wind to the casting 108 and the optical parts such as the light tunnel 110.

A mirror 114 for reflecting light that has passed through the transmission member 112 is disposed in the casting 108. A DMD 115 for again reflecting the light reflected from the mirror 114 and thereby supplying it to the projection lens 109 is disposed outside the opening 108b (see FIG. 19) of the casting 108. As shown in FIG. 18, the DMD 115 is provided with a device portion 115a in which a number of mirrors for reflecting light are arranged. As shown in FIG. 17, a lens 116 and a light shield plate 117 are disposed between the DMD 115 and the mirror 114. The lens 116 has a function of focusing light reflected from the mirror 114 on the device portion 115a of the DMD 115. As shown in FIG. 18, the light shield plate 117 has, at the center, an aperture window 117a which allows passage of light, and is attached to the bottom portion of the casting 108 with screws 130. The light shield plate 117 has a function of preventing light from leaking from a gap 160 between the opening 108b of the casting 108 and the DMD 115.

The DMD 115 and a terminal plate 119 are fitted in a fixing member 118 (see FIG. 20). Thus, the fixing member 118 has a function of fixing the DMD 115 and the terminal plate 119. As shown in FIG. 20, the terminal plate 119 is formed with two positioning bosses 119a at prescribed positions. The terminal plate 119 has a function of electrically connecting the DMD 115 to a printed wiring board 120. The terminal plate 119 and the printed wiring board 120 are formed with respective insertion portions 119b and 120a at positions corresponding to the device portion 115a of the DMD 115. The printed wiring board 120 is formed with four screw insertion portions 120b at positions corresponding to the threaded holes 108e of the four bosses 108d of the casting 108. The printed wiring board 120 is formed with positioning holes 120c at positions corresponding to the positioning bosses 119a of the terminal plate 119.

A heat sink member 121 for radiating heat from the DMD 115 is disposed so as to be in contact with the back surface of the DMD 115 through the insertion portion 119b of the terminal plate 119 and the insertion portion 120a of the printed wiring board 120. As shown in FIGS. 18 to 20, the heat sink member 121 has a base portion 121a, a contact portion 121b (see FIG. 18), and four flat heat radiation fins 121c. The base portion 121a of the heat sink member 121 is formed with four screw insertion holes 121d (see FIG. 20) at positions corresponding to the threaded holes 108e of the bosses 108d of the casting 108 and the screw insertion portions 120b of the printed wiring board 120. As shown in FIG. 18, screws 140 are inserted in the four screw insertion holes 121d. The contact portion 121b of the heat sink member 121 is integral with and projects from the base portion 121a. The contact portion 121b is inserted in the insertion portion 120a of the printed wiring board 120 and the insertion portion 119b of the terminal plate 119, and is in contact with the DMD 115 via a heat radiation sheet 122. With this structure, the heat radiation sheet 122 conducts heat from the DMD 115 to the contact portion 121b of the heat sink member 121.

Next, a method for mounting the DMD 115 on the casting 108 of the one conventional projector will be described with reference to FIG. 20. First, as shown in FIG. 20, the DMD 115 and the terminal plate 119 are fitted into the fixing member 118 and the positioning bosses 119a of the terminal plate 119 are inserted into the positioning holes 120c of the printed wiring board 120. As a result, the DMD 115 is mounted on the printed wiring board 120. Then, the screws 140 are inserted into the screw insertion holes 120d of the printed wiring board 120 and the screw insertion holes 121d of the heat sink 121 and are kept inserted therein. As a result, the state of FIG. 19 is established. In this state, as shown in FIG. 19, the screws 140 inserted in the screw insertion holes 120d of the printed wiring board 120 (see FIG. 20) and the screw insertion holes 121d of the heat sink 121 (see FIG. 20) are screwed into the threaded holes 108e of the casting 108. The mounting of the DMD 115 on the casting 108 is thus completed. During that course, the printed wiring board 120 comes into contact with the projection 108c of the casting 108 and the DMD 115 is thereby positioned.

Next, the operation of the one conventional projector will be described with reference to FIG. 17. First, as shown in FIG. 17, light emitted from the light source 105a of the light source lamp 105 is focused by the reflector 105b of the light source lamp 105 and thereby brought to the entrance portion 110a of the light tunnel 110. The light entering the light tunnel 110 at its entrance portion 110a is shaped into a rectangular shape and output from the exit portion 110b of the light tunnel 110. As traveling in a direction indicated by arrow A, the light that is output from the exit portion 110b of the light tunnel 110 passes through the transmission member 112 and shines on the mirror 114. The light incident on the mirror 114 is reflected by the mirror 114 to a direction indicated by arrow B. The light reflected from the mirror 114 shines on the DMD 115 via the lens 116. The light incident on the DMD 115 is reflected by the device portion 115a of the DMD 115 to a direction indicated by arrow C and thereby supplied to the projection lens 109. As a result, an image is projected onto a screen or the like from the projection lens 109.

In the conventional projector shown in FIGS. 16 to 20, the DMD 115 is positioned in such a manner that the printed wiring board 120 on which the DMD 115 is mounted is brought into contact with the projection 108c of the casting 108. Therefore, the DMD 115 is positioned with the position of the casting 108 as a reference and it is difficult to adjust the position of the DMD 115 after it has been mounted. This results in a problem that the casting 108 is required to be high in dimensional accuracy. This leads to problems that the efficiency of manufacture of the casting 108 is lowered and its manufacturing cost is increased.

On the other hand, in the projection display device disclosed in JP-A-2004-45733, the dedicated angle adjustment mechanism including the gear, its pivotally supporting means, adjustment dial, and its pivotally supporting means is necessary for adjusting the angle of the DMD. Therefore, this display device has a problem the angle adjustment mechanism is complex.

The projector disclosed in JP-A-11-202408 has a problem that the angles of the liquid crystal panels (light modulation elements) cannot be adjusted directly.

The projector disclosed in Japanese Utility Model Registration No. 3,092,508 has a problem that the angle of the DMD (light modulation element) cannot be adjusted directly, because the DMD is mounted on the body.

### SUMMARY OF THE INVENTION

The present invention provides a projector in which a position adjustment (angle adjustment) for a light modulation element is enabled by a simple structure.

A projector according to a first aspect of the invention comprises a light source lamp; a projection lens for projecting an image; a light modulation element for reflecting light radiated from the light source lamp and thereby supplying it to the projection lens; a printed wiring board for controlling the light modulation element mounted on the printed wiring board; and an optical part holder mounted with the projection lens and the light modulation element, wherein the printed wiring board is mounted by at least four screw members which are arranged so as to surround the light modulation element, the screw members are attached to the optical part holder via compression coil springs which are disposed between the printed wiring board and the optical part holder, and the light modulation element is position-controlled by adjusting amounts of turning of the screw members.

In the projector according to the first aspect, the printed wiring board that is mounted with the light modulation element is mounted on the optical part holder by the screw members and the position of the light modulation element is adjusted by adjusting the amounts of turning of the screw members. Therefore, the position of the light modulation element can be adjusted by adjusting the amounts of turning of the screw members even after the printed wiring board mounted with the light modulation element has been mounted on the optical part holder. As a result, the dimensional accuracy required for the optical part holder which is involved in the positioning of the light modulation element can be lowered, which facilitates the manufacture of the optical part holder, which in turn makes it possible to increase the efficiency of manufacture of the optical part holder and lower its manufacturing cost. Further, the position (angle) of the light modulation element is adjusted by using the at least four screw members for mounting, on the optical part holder, the printed wiring board that is mounted with the light modulation element. Since it is not necessary to separately provide a dedicated angle adjustment mechanism, the position (angle) of the light modulation element can be adjusted by a simple structure. Further, the printed wiring board is mounted by the at least four screw members which are arranged so as to surround the light modulation element. Therefore, horizontal and vertical position adjustments (angle adjustments) of the printed wiring board that is mounted with the light modulation element can be performed by adjusting the amounts of turning of the at least four respective screw members. Still further, the screw members are attached to the optical part holder by using the compression coil springs that are interposed between the printed wiring board and the optical part holder. Therefore, because of the urging forces of the compression coil springs, the printed wiring board is pressed toward the heads of the screw members by constant pressing forces. As a result, as the amounts of turning of the screw members are adjusted, the position of the printed wiring board can be changed by a length corresponding to the amounts of turning. This makes it easier to change the position of the light modulation element that is mounted on the printed wiring board by a length corresponding to the amounts of turning of the screw members.

A projector according to a second aspect of the invention comprises a light source lamp; a projection lens for projecting an image; a light modulation element for reflecting light radiated from the light source lamp and thereby supplying it to the projection lens; a printed wiring board for controlling the light modulation element mounted on the printed wiring board; and an optical part holder mounted with the projection lens and the light modulation element, wherein the printed wiring board mounted with the light modulation element is mounted on the optical part holder by a screw member, and the light modulation element is position-controlled by adjusting an amount of turning of the screw member.

In the projector according to the second aspect, as described above, the printed wiring board that is mounted with the light modulation element is mounted on the optical part holder by the screw member and the position of the light modulation element is adjusted by adjusting the amount of turning of the screw member. Therefore, the position of the light modulation element can be adjusted by adjusting the amount of turning of the screw member even after the printed wiring board mounted with the light modulation element has been mounted on the optical part holder. As a result, the dimensional accuracy required for the optical part holder which is involved in the positioning of the light modulation element can be lowered, which facilitates the manufacture of the optical part holder, which in turn makes it possible to increase the efficiency of manufacture of the optical part holder and lower its manufacturing cost. Further, the position (angle) of the light modulation element is adjusted by using the screw member for mounting, on the optical part holder, the printed wiring board that is mounted with the light modulation element. Since it is not necessary to separately provide a dedicated angle adjustment mechanism, the position (angle) of the light modulation element can be adjusted by a simple structure.

In the projector according to the second aspect, it is preferable that the printed wiring board be mounted by at least four screw members which are arranged so as to surround the light modulation element. With this configuration, horizontal and vertical position adjustments (angle adjustments) of the printed wiring board that is mounted with the light modulation element can be performed by adjusting the amounts of turning of the at least four respective screw members.

In the projector according to the second aspect, it is preferable that the printed wiring board and the light modulation element be mounted on the optical part holder, that a heat sink member for cooling the light modulation element be connected to a lower part of the optical part holder and be thereby integral with the optical part holder, and that the printed wiring board be mounted on the optical part holder by at least two screw members at positions that are on an upper part of the optical part holder and are separated from each other by a predetermined distance. With this configuration, even if an upper portion of the heat sink member which is connected to the lower part of the optical part holder and is thereby integral with the optical part holder is bent in the horizontal direction, the bend can be corrected for by the screw members. Even in the case where the optical part holder and the heat sink member are integral with each other, a position adjustment of the printed wiring board that is mounted on the heat sink member can be performed in the above manner and hence a position adjustment of the light modulation element that is mounted on the printed wiring board can be performed. As a result, the dimensional accuracy required for the optical part holder which is involved in the positioning of the light modulation element can be lowered, which facilitates the manufacture of the optical part holder, which in turn makes it possible to increase the efficiency of manufacture of the optical part holder and lower its manufacturing cost. Further, since a position adjustment of the light modulation element is performed by using the at least two screw members for attaching, to the optical part holder, the printed wiring board that is mounted with the light modulation element, a position adjustment of the light modulation element can be performed by a simple structure.

In the projector according to the second aspect, it is preferable that the screw member be attached to the optical part holder via a compression coil spring which is disposed between the printed wiring board and the optical part holder. With this configuration, because of the urging force of the compression coil spring, the printed wiring board is pressed toward the head of the screw member by constant pressing force. As a result, as the amount of turning of the screw member is adjusted, the position of the printed wiring board can be changed by a length corresponding to the amount of turning. This makes it easier to change the position of the light modulation element that is mounted on the printed wiring board by a length corresponding to the amount of turning of the screw member.

### BRIEF DESCRIPTION OF THE DRAWINGS

FIG. 1 is a perspective view showing the entire configuration of a projector according to a first embodiment of the present invention;

FIG. 2 is a top view of the projector according to the first embodiment shown in FIG. 1;

FIG. 3 is a sectional view for description of a structure for mounting of a printed wiring board on a casting in the projector according to the first embodiment shown in FIG. 1;

FIG. 4 is a perspective view for description of a structure for mounting of a DMD on the printed wiring board in the projector according to the first embodiment shown in FIG. 1;

FIG. 5 is a perspective view showing the casting, the printed wiring board, and a heat sink member of the projector according to the first embodiment shown in FIG. 1;

FIG. 6 is a side view showing the casting, the printed wiring board, and the heat sink member of the projector according to the first embodiment shown in FIG. 1;

FIG. 7 is a front view showing the printed wiring board and the heat sink member of the projector according to the first embodiment shown in FIG. 1;

FIG. 8 is a sectional view for description of the structure for mounting of the printed wiring board on the casting in the projector according to the first embodiment shown in FIG. 1;

FIG. 9 is a sectional view for description of the structure for mounting of the printed wiring board on the casting in the projector according to the first embodiment shown in FIG. 1;

FIG. 10 is a top view for description of a method for adjusting the position (angle) of the printed wiring board and the DMD of the projector according to the first embodiment shown in FIG. 1;

FIG. 11 is a sectional view for description of the method for adjusting the position (angle) of the printed wiring board and the DMD of the projector according to the first embodiment shown in FIG. 1;

FIG. 12 is a perspective view showing a casting of a projector according to a second embodiment of the invention;

FIG. 13 is a side view showing the casting of the projector according to the second embodiment of the invention;

FIG. 14 is a sectional view showing a printed wiring board and the casting of the projector according to the second embodiment of the invention;

FIG. 15 is a front view showing the printed wiring board and a heat sink portion of the projector according to the second embodiment of the invention;

FIG. 16 is a perspective view showing the entire configuration of one conventional projector;

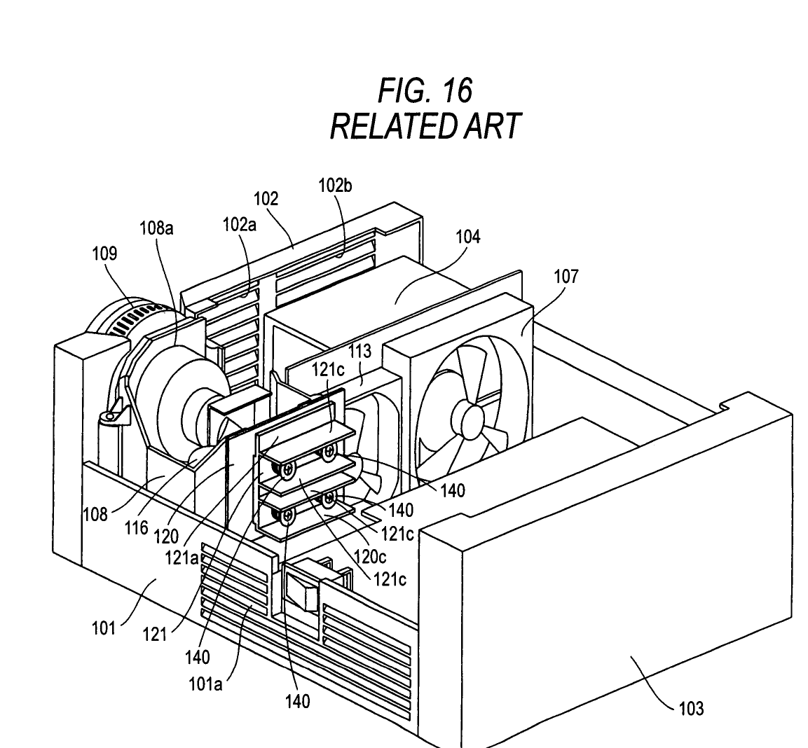

FIG. 17 is a plan view of the one conventional projector of FIG. 16;

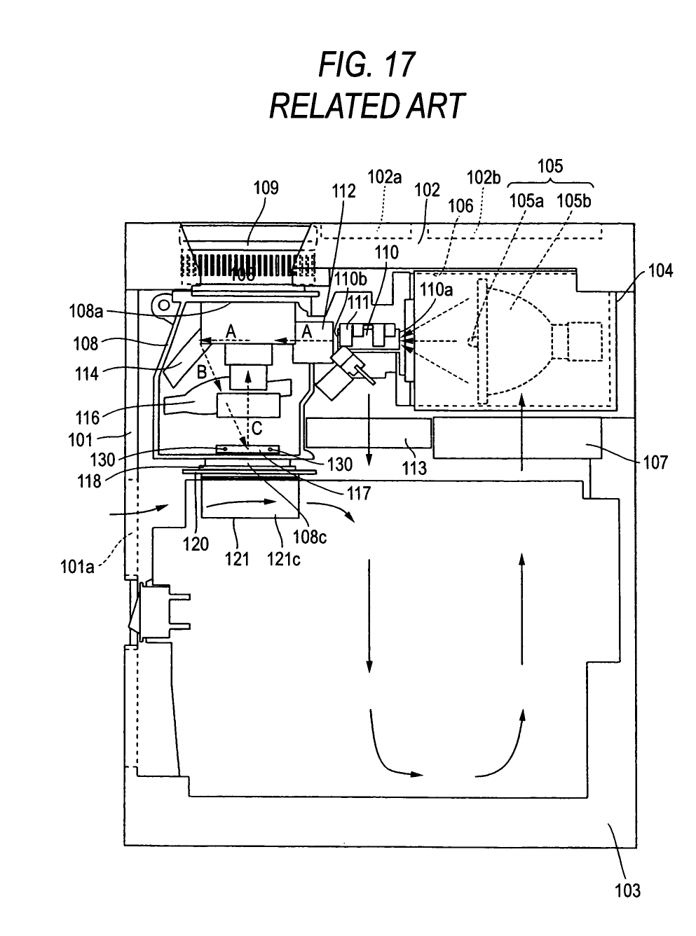

FIG. 18 is a sectional view for description of a structure for mounting of a printed wiring board and a heat sink member on a casting in the one conventional projector of FIG. 16;

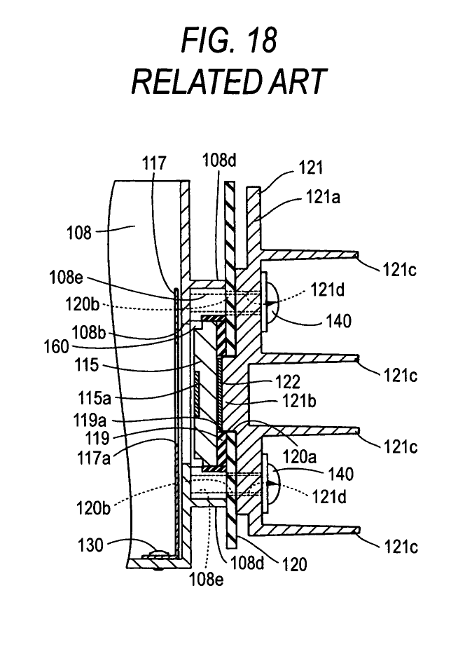

FIG. 19 is a perspective view for description of the structure for mounting of the printed wiring board and the heat sink member on the casting in the one conventional projector of FIG. 16; and

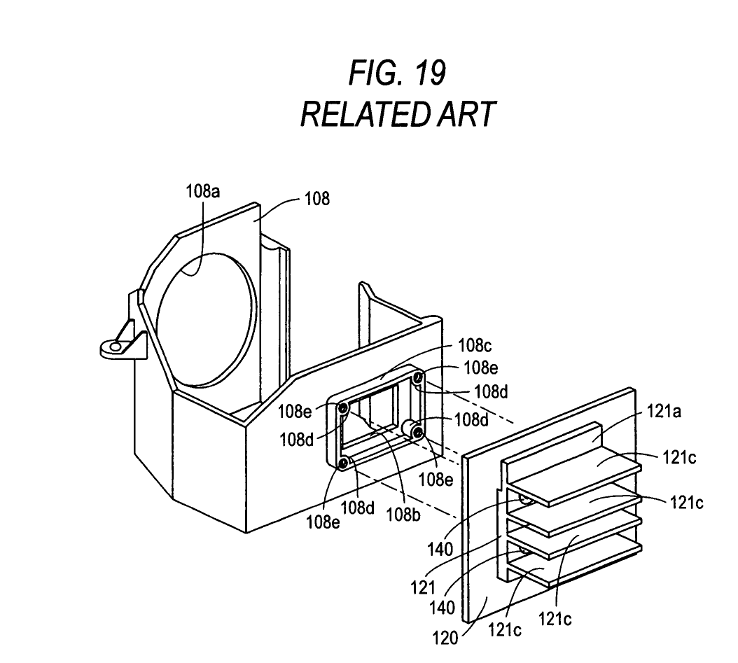

FIG. 20 is a perspective view for description of a structure for mounting of a DMD on the printed wiring board in the one conventional projector of FIG. 16.

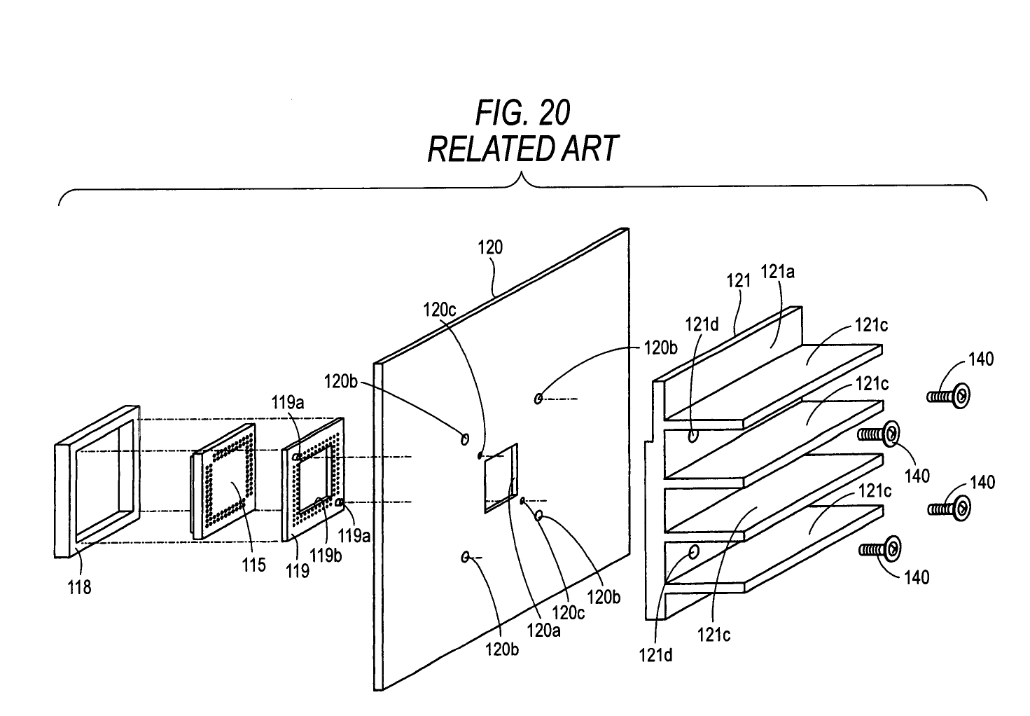

### DETAILED DESCRIPTION OF THE INVENTION

Embodiments of the present invention will be hereinafter described with reference to the drawings.

### First Embodiment

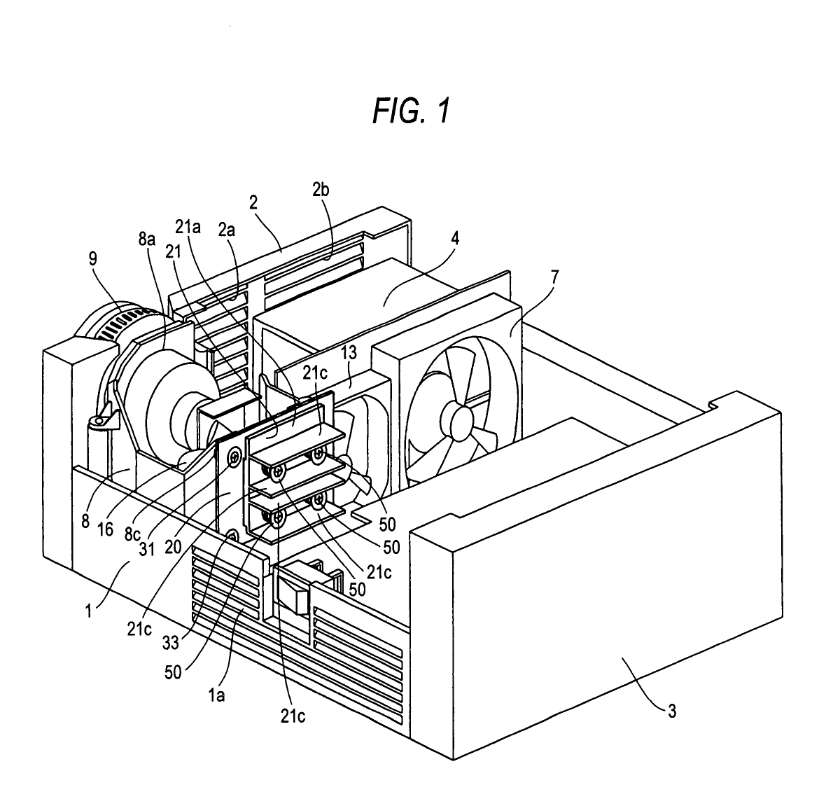

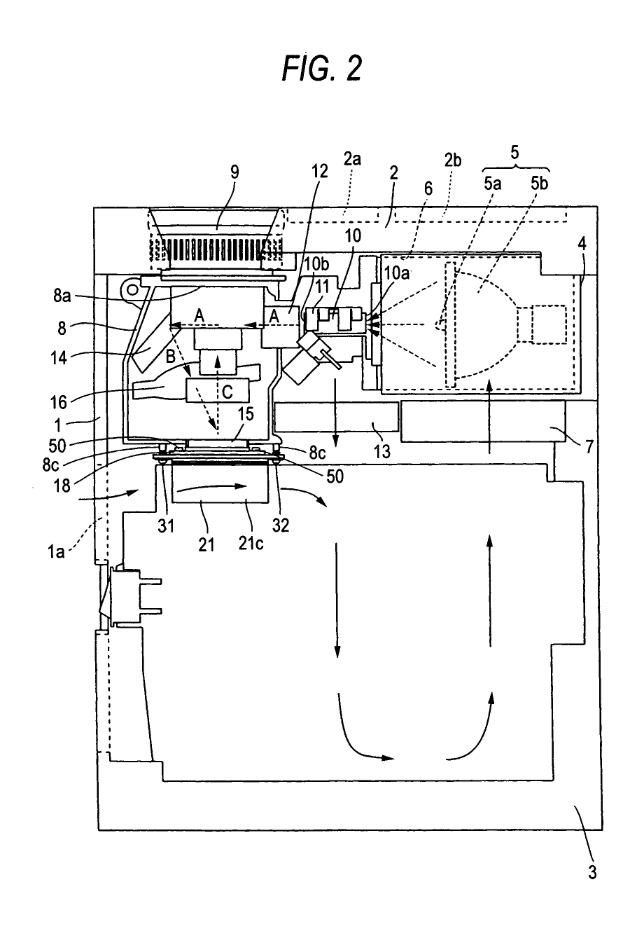

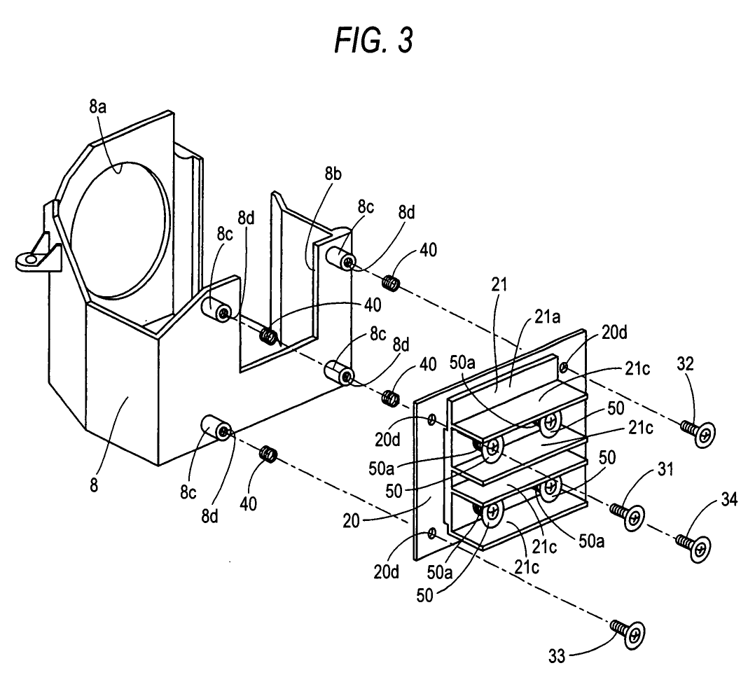

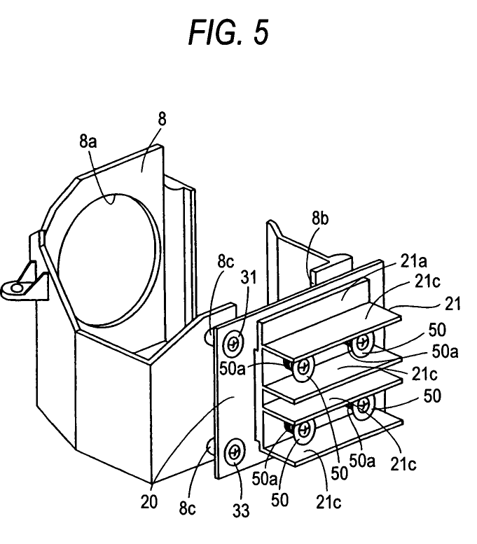

FIG. 1 is a perspective view showing the entire configuration of a projector according to a first embodiment of the invention. FIG. 2 is a top view of the projector according to the first embodiment shown in FIG. 1. FIGS. 3 to 8 are for description of detailed structures of the projector according to the first embodiment shown in FIG. 1. The configuration of the projector according to the first embodiment of the invention will be described with reference to FIGS. 1 to 8.

As shown in FIG. 1, the projector according to the first embodiment of the invention is equipped with a lower case 1, a front case 2, and a rear case 3. A side wall of the lower case 1 is formed with air inlets 1a through which to take in air. The front case 2 and the rear case 3 are attached to the lower case 1. The front case 2 is formed with air inlets 2a through which to take in air and air outlets 2b through which to discharge air.

A lamp case holder 4 made of a heat-resistant resin is disposed in the lower case 1 near the front case 2. As shown in FIG. 2, a lamp case 6 which is mounted with a light source lamp 5 is housed in the lamp case holder 4. The light source lamp 5 has a light source 5a for emitting light and a reflector 5b for reflecting and thereby focusing the light emitted from the light source 5a. As shown in FIGS. 1 and 2, a temperature control fan 7 for controlling the temperature of the light source lamp 5 by guiding a wind to the light source lamp 5 at a prescribed rate is disposed beside the lamp case holder 4 and the lamp case 6 mounted with the light source lamp 5.

A casting 8 made of Mg (magnesium) having a lens mounting portion 8a is disposed in the lower case 1. The casting 8 is an example of an “optical part holder” of the invention. A projection lens 9 for projecting an image is mounted on the lens mounting portion 8a of the casting 8. As shown in FIG. 3, an opening 8b is formed in the casting 8 at such a position as to be opposed to the lens mounting portion 8a. The casting 8 is formed with four bosses 8c in such a manner that it surrounds the opening 8b. The bosses 8c are formed with respective threaded holes 8d. As shown in FIG. 2, a light tunnel 10 for shaping light into a rectangular shape is attached to the casting 8 at a position where light radiated from the light source 5a of the light source lamp 5 is focused. The light tunnel 10 is fixed to the casting 8 by means of a light tunnel clip 11.

The light tunnel 10 has an entrance portion 10a an which light coming from the light source lamp 5 enters the light tunnel 10 and an exit portion 10b at which the light exits from the light tunnel 10, and the light tunnel 10 assumes a pipe-like shape having four walls. A transmission member 12 for transmitting light that has been shaped by the light tunnel 10 is attached to the casting 8 on the exit portion 10b side of the light tunnel 10. A cooling fan 13 is disposed beside the light tunnel 10 and the transmission member 12 so as to be juxtaposed with the temperature control fan 7. The cooling fan 13 is provided to cool the casting 8 and optical parts such as the light tunnel 10 by taking in air through the air inlets 2a of the front case 2 and guiding a wind to the casting 8 and the optical parts such as the light tunnel 10.

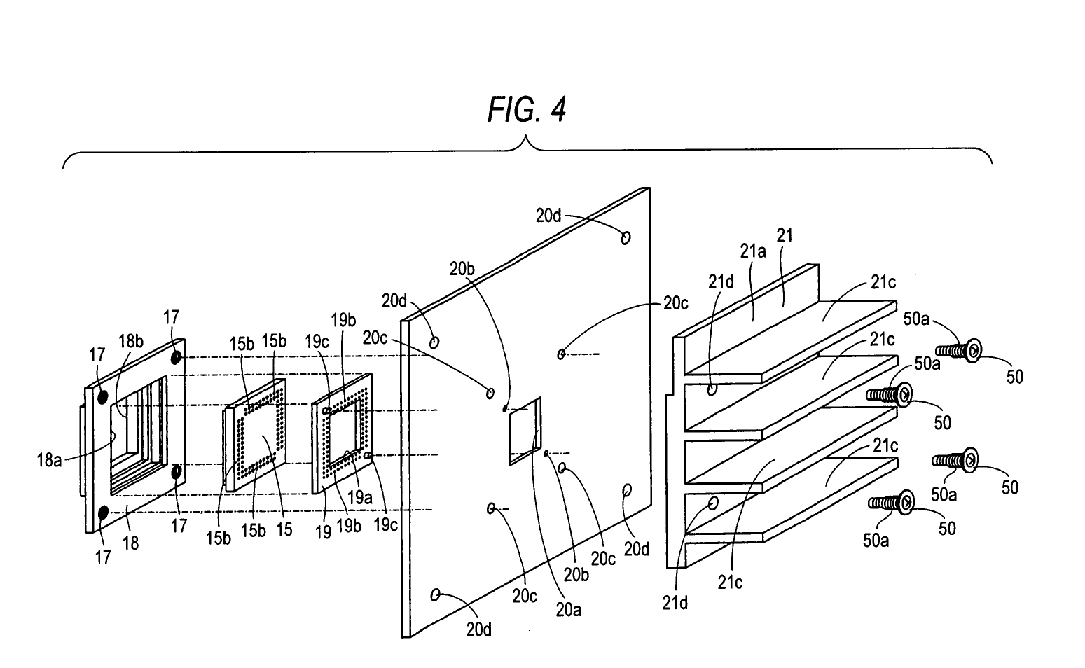

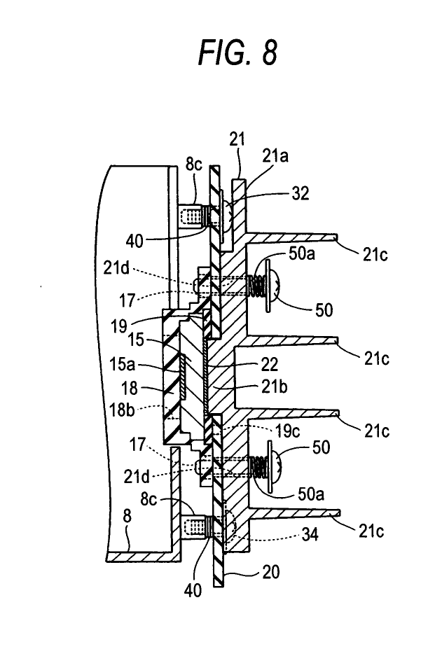

A mirror 14 for reflecting light that has passed through the transmission member 12 is disposed in the casting 8. A DMD 15 for again reflecting the light reflected from the mirror 14 and thereby supplying it to the projection lens 9 is disposed outside the opening 8b (see FIG. 3) of the casting 8. The DMD 15 is an example of a “light modulation element” of the invention. The DMD 15 is provided with a device portion 15a (see FIG. 8) in which a number of mirrors for reflecting light are arranged. As shown in FIG. 2, a lens 16 for focusing the light reflected from the mirror 14 on the device portion 15a (see FIG. 8) of the DMD 15 is disposed between the DMD 15 and the mirror 14. As shown in FIG. 4, the back surface of the DMD 15 is formed with plural terminal portions 15b.

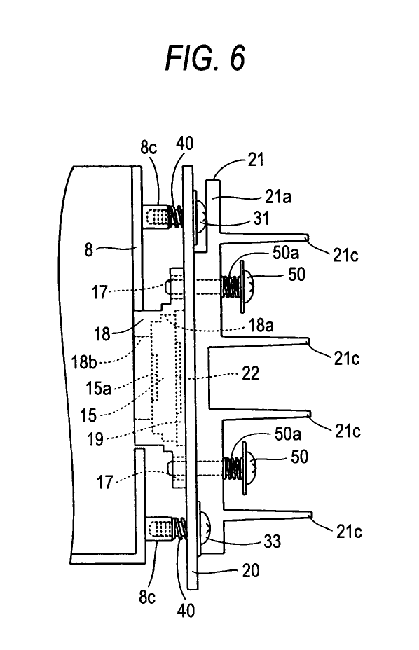

As shown in FIG. 6, the DMD 15 is mounted on a printed wiring board 20 via a resin terminal plate 19 by means of a resin fixing member 18 in which four metal insert nuts 17 (see FIG. 4) are buried. The surface of the fixing member 18 on the side where the DMD 15 is mounted is formed with a recessed accommodation portion 18a in which the DMD 15 and the terminal plate 19 are accommodated. A light passage window 18b which allows passage of light is formed through the fixing member 18 so as to be adjacent to the bottom of its accommodation portion 18a. The portion, formed with the light passage window 18b, of the fixing member 18 is inserted in the opening 8b of the casting 8. As shown in FIG. 4, the terminal plate 19 and the printed wiring board 20 are formed with respective insertion portions 19a and 20a at positions corresponding to the device portion 15a of the DMD 15. The terminal plate 19 is provided with plural metal terminal portions 19b having resilience at positions corresponding to the terminal portions 15b of the DMD 15. The plural metal terminal portions 19b penetrate through the terminal plate 19 and are formed so as to come in contact with plural conductor portions (not shown) of the printed wiring board 20 and the terminal portions 15b of the DMD 15. Terminal plate 19 is formed integrally with two positioning bosses 19c at prescribed positions. The printed wiring board 20 is formed with positioning holes 20b at positions corresponding to the positioning bosses 19c of the terminal plate 19. The printed wiring board 20 is formed with four screw insertion portions 20c at positions corresponding to the four insert nuts 17 which are buried in the fixing member 18.

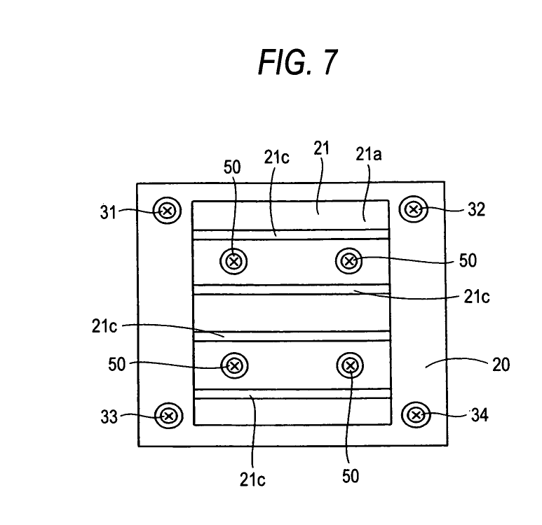

In the first embodiment, as shown in FIG. 3, the printed wiring board 20 is formed with four screw insertion holes 20d at positions corresponding to the threaded holes 8d of the four bosses 8c of the casting 8. As shown in FIG. 7, the printed wiring board 20 is mounted by screws 31 to 34 that are located at four corner positions so as to surround the DMD 15 which is mounted on the printed wiring board 20. The four screws 31 to 34 are attached to the casting 8 via compression coil springs 40 (see FIG. 3) that are disposed between the printed wiring board 20 and the casting 8.

As shown in FIG. 6, a heat sink member 21 made of Al (aluminum) for radiating heat from the DMD 15 is disposed for the DMD 15 so as to be in contact with the back surface of the DMD 15 through the insertion portion 19a of the terminal plate 19 and the insertion portion 20a of the printed wiring board 20. As shown in FIGS. 3 to 6, the heat sink member 21 has a base portion 21a, a contact portion 21b (see FIG. 8), and heat radiation fins 21c. As shown in FIG. 4, the base portion 21a of the heat sink member 21 is formed with four screw holes 21d. Four spring-added screws 50 having compression coil springs 50a are inserted in the four screw holes 21d. The spring-added screws 50 are inserted in the screw holes 21d of the heat sink member 21 and screwed into the insert nuts 17 buried in the fixing member 18 through the screw insertion portions 20c (see FIG. 4) of the printed wiring board 20, whereby the fixing member 18, the DMD 15, the terminal plate 19, and the printed wiring board 20 are attached to the heat sink member 21. That is, in the first embodiment, since the DMD 15 is fixed in such a state as to be pulled toward the heat sink member 21 side, the DMD 15 is positioned with the heat sink member 21 as a reference. The compression coil springs 50a in which the spring-added screws 50 are inserted are provided to bring a heat radiation sheet 22 (see FIG. 8; attached to the heat sink member 21) into contact with the back surface of the DMD 15 with prescribed pressing force. The contact portion 21b of the heat sink member 21 is integral with and projects from the base portion 21a of the heat sink member 21. The contact portion 21b is inserted in the insertion portion 20a of the printed wiring board 20 and the insertion portion 19a of the terminal plate 19, and is in contact with the DMD 15 via the heat radiation sheet 22. With this structure, the heat radiation sheet 22 conducts heat from the DMD 15 to the contact portion 21b of the heat sink member 21.

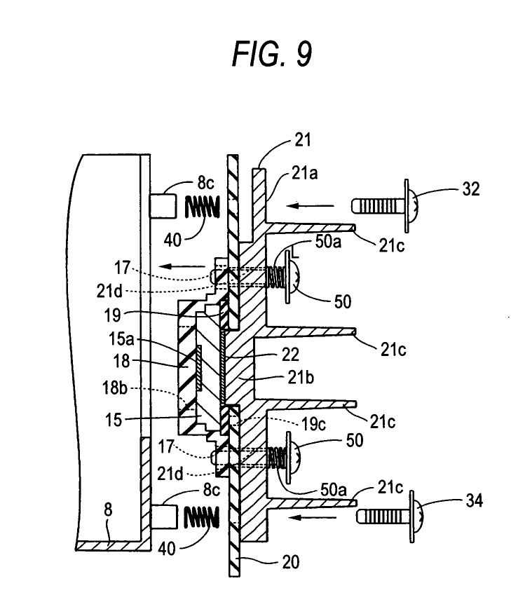

FIG. 9 is a sectional view showing a method for mounting the DMD on the casting in the projector according to the first embodiment shown in FIG. 1. Next, the method for mounting the DMD 15 on the casting 8 of the projector according to the first embodiment will be described with reference to FIGS. 3, 4, and 9. First, as shown in FIG. 4, the DMD 15 and the terminal plate 19 are inserted into the accommodation portion 18a of the fixing member 18 and the positioning bosses 19a of the terminal plate 19 are inserted into the positioning holes 20b of the printed wiring board 20. As a result, the DMD 15 is mounted on the printed wiring board 20. In this state, the spring-added screws 50 are screwed into the insert nuts 17 which are buried in the fixing member 18, whereby the state shown in FIGS. 3 and 9 is established. Further, in this state, as shown in FIGS. 3 and 9, the screws 31 to 34 are inserted into the screw insertion holes 20d of the printed wiring board 20 and screwed into the threaded holes 8d of the bosses 8c of the casting 8. The mounting of the DMD 15 on the casting 8 is thus completed. During that course, the position of the DMD 15 mounted on the printed wiring board 20 can be adjusted by adjusting the amounts of turning of the screws 31 to 34.

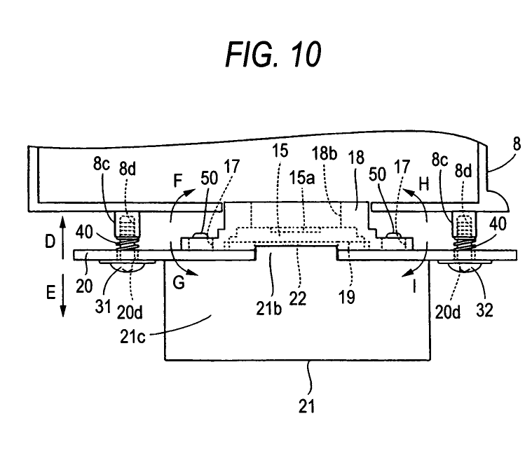

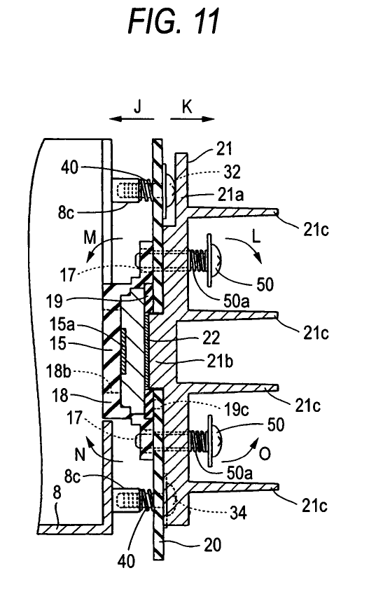

FIGS. 10 and 11 are for description of position adjustments of the printed wiring board and the DMD of the projector according to the first embodiment shown in FIG. 1. Next, a method for adjusting the position (angle) of the printed wiring board 20 and the DMD 15 using the screws 31 to 34 will be described with reference to FIGS. 10 and 11. First, a horizontal position adjustment (angle adjustment) of the printed wiring board 20 and the DMD 15 will be described. The screws 31 and 33 (see FIG. 7) are moved in a direction indicated by arrow D in FIG. 10 by tightening them in the state of FIG. 10. During that course, the printed wiring board 20 and the DMD 15 are rotated in a direction indicated by arrow F in FIG. 10 with the screws 32 and 34 (see FIG. 7) as supporting points. In contrast, the screws 31 and 33 are moved in a direction indicated by arrow E in FIG. 10 by loosening them. During that course, the printed wiring board 20 and the DMD 15 are rotated in a direction indicated by arrow G in FIG. 10 with the screws 32 and 34 as supporting points. Likewise, the screws 32 and 34 are moved in the direction indicated by arrow D in FIG. 10 by tightening them in the state of FIG. 10. During that course, the printed wiring board 20 and the DMD 15 are rotated in a direction indicated by arrow H in FIG. 10 with the screws 31 and 33 as supporting points. In contrast, the screws 32 and 33 are moved in the direction indicated by arrow E in FIG. 10 by loosening the screws 32 and 34. During that course, the printed wiring board 20 and the DMD 15 are rotated in a direction indicated by arrow I in FIG. 10 with the screws 31 and 33 as supporting points. In this manner, a horizontal position adjustment (angle adjustment) of the printed wiring board 20 and the DMD 15 is enabled.

Next, a vertical position adjustment (angle adjustment) of the printed wiring board 20 and the DMD 15 will be described. The screw 31 (see FIG. 7) and the screw 32 are moved in a direction indicated by arrow J in FIG. 10 by tightening them in the state of FIG. 11. During that course, the printed wiring board 20 and the DMD 15 are rotated in a direction indicated by arrow M in FIG. 11 with the screw 33 (see FIG. 7) and the screw 34 as supporting points. In contrast, the screws 31 and 32 are moved in a direction indicated by arrow K in FIG. 11 by loosening them. During that course, the printed wiring board 20 and the DMD 15 are rotated in a direction indicated by arrow L in FIG. 11 with the screws 33 and 34 as supporting points. Likewise, the screws 33 and 34 are moved in the direction indicated by arrow J in FIG. 11 by tightening them in the state of FIG. 11. During that course, the printed wiring board 20 and the DMD 15 are rotated in a direction indicated by arrow N in FIG. 11 with the screws 31 and 32 as supporting points. In contrast, the screws 33 and 34 are moved in the direction indicated by arrow K in FIG. 11 by loosening them. During that course, the printed wiring board 20 and the DMD 15 are rotated in a direction indicated by arrow O in FIG. 11 with the screws 31 and 32 as supporting points. In this manner, a vertical position adjustment (angle adjustment) of the printed wiring board 20 and the DMD 15 is enabled. As a result, horizontal and vertical position adjustments (angle adjustments) can be performed by adjusting the amounts of the turning of the screws 31 to 34 with respect to the threaded holes of the bosses 8c of the casting 8.

Next, the operation of the projector according to the first embodiment of the invention will be described with reference to FIG. 2. First, light emitted from the light source 5a of the light source lamp 5 is focused by the reflector 5b of the light source lamp 5 and thereby brought to the entrance portion 10a of the light tunnel 10. The light entering the light tunnel 10 at its the entrance portion 10a is shaped into a rectangular shape and output from the exit portion 10b of the light tunnel 10. As traveling in a direction indicated by arrow A, the light that is output from the exit portion 10b of the light tunnel 10 passes through the transmission member 12 and shines on the mirror 14. The light incident on the mirror 14 is reflected by the mirror 14 to a direction indicated by arrow B. The light reflected from the mirror 14 shines on the DMD 15 via the lens 16. The light incident on the DMD 15 is reflected by the device portion 15a of the DMD 15 to a direction indicated by arrow C and thereby supplied to the projection lens 9. As a result, an image is projected onto a screen or the like from the projection lens 9.

In the first embodiment, as described above, the printed wiring board 20 that is mounted with the DMD 15 is mounted on the casting 8 by the screws 31 to 34 and the position of the DMD 15 is adjusted by adjusting the amounts of turning of the screws 31 to 34. Therefore, the position of the DMD 15 can be adjusted by adjusting the amounts of turning of the screws 31 to 34 even after the printed wiring board 20 mounted with the DMD 15 has been mounted on the casting 8. As a result, the dimensional accuracy required for the casting 8 which is involved in the positioning of the DMD 15 can be lowered, which facilitates the manufacture of the casting 8, which in turn makes it possible to increase the efficiency of manufacture of the casting 8 and lower its manufacturing cost.

In the first embodiment, the position (angle) of the DMD 15 is adjusted by using the four screws 31 to 34 for mounting, on the casting 8, the printed wiring board 20 that is mounted with the DMD 15. Since it is not necessary to separately provide a dedicated angle adjustment mechanism, the position (angle) of the DMD 15 can be adjusted by a simple structure.

The printed wiring board 20 is mounted by the four screws 31 to 34 which are arranged so as to surround the DMD 15. Therefore, horizontal and vertical position adjustments (angle adjustments) of the printed wiring board 20 that is mounted with the DMD 15 can be performed by adjusting the amounts of turning of the four respective screws 31 to 34.

In the first embodiment, the screws 31 to 34 are attached to the casting 8 by using the compression coil springs 40 that are interposed between the printed wiring board 20 and the casting 8. Therefore, because of the urging forces of the compression coil springs 40, the printed wiring board 20 is pressed toward the heads of the screws 31 to 34 by constant pressing forces. As a result, as the amounts of turning of the screws 31 to 34 are adjusted, the position of the printed wiring board 20 can be changed by a length corresponding to the amounts of turning. This makes it easier to change the position of the DMD 15 that is mounted on the printed wiring board 20 by a length corresponding to the amounts of turning of the screws 31 to 34.

### Second Embodiment

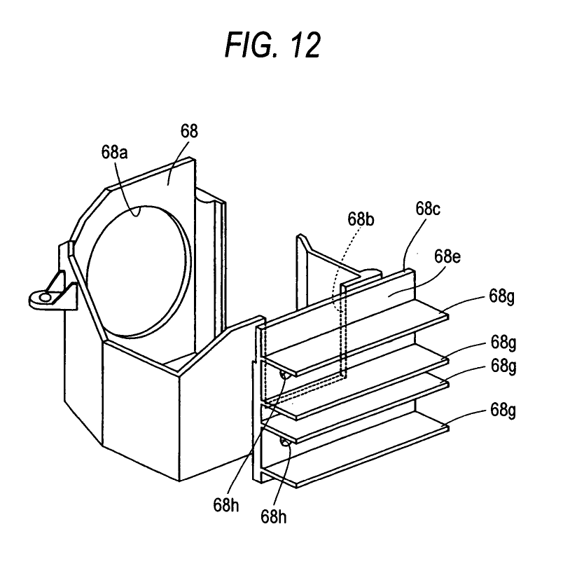

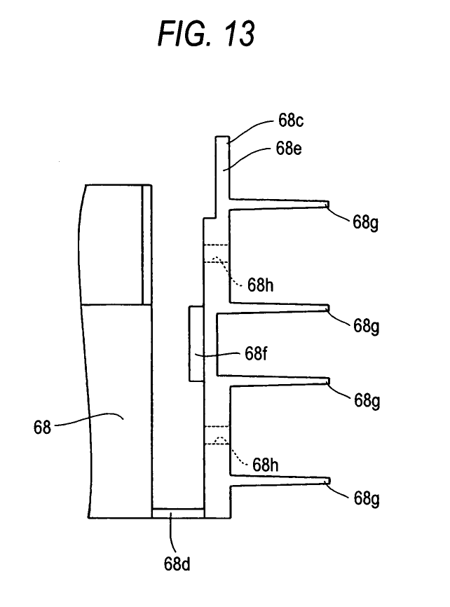

FIGS. 12 to 15 show detailed structures of a projector according to a second embodiment of the invention. In the second embodiment, an example in which unlike in the first embodiment the invention is applied to a structure in which a heat sink member is integral with a casting will be described with reference to FIGS. 12 to 15. The structures other than the casting are the same as in the first embodiment and hence will not be described.

In the projector according to the second embodiment, as shown in FIG. 12, the projection lens 9 for projecting an image is mounted on a lens mounting portion 68a of a casting 68 made of Al (aluminum). The casting 68 is an example of the “optical part holder” of the invention. An opening 68b is formed in the casting 68 at such a position as to be opposed to the lens mounting portion 68a.

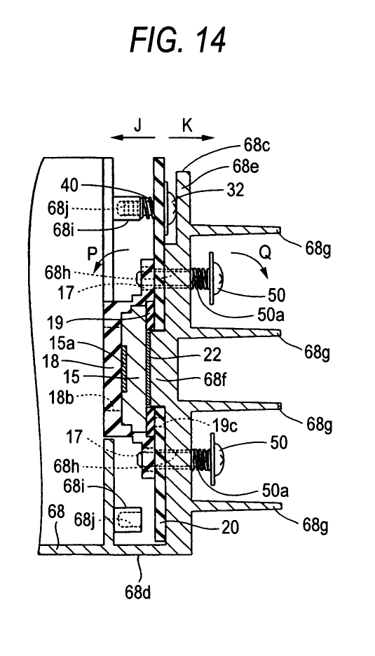

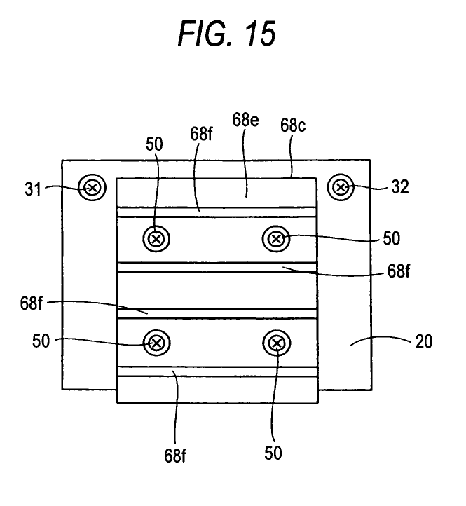

In the second embodiment, as shown in FIG. 14, the printed wiring board 20 and the DMD 15 are mounted on the casting 68. A portion, under the opening 68b, of the casting 68 is provided integrally with a link portion 68d for linkage with a heat sink portion 68c which is made of Al (aluminum) and serves to cool the DMD 15. The heat sink portion 68c is an example of a “heat sink member” of the invention. The heat sink portion 68c of the casting 68 has a base portion 68e, a contact portion 68f, and radiation fins 68g. As shown in FIG. 12, the base portion 68e of the heat sink portion 68c is formed with four screw holes 68h. Spring-added screws 50 having compression coil springs 50a are inserted in the four screw holes 68h. The spring-added screws 50 are screwed into the insert nuts 17 buried in the fixing member 18 through the screw insertion portions 20c of the printed wiring board 20, whereby the fixing member 18, the DMD 15, the terminal plate 19, and the printed wiring board 20 are attached to the heat sink portion 68c of the casting 68. That is, in the second embodiment, since the DMD 15 is fixed in such a state as to be pulled toward the heat sink portion 68c side, the DMD 15 is positioned with the heat sink portion 68 of the casting 68 as a reference. The casting 68 is formed with bosses 68i at four positions that surround the opening 68b. The bosses 68i are formed with respective threaded holes 68j. As shown in FIGS. 14 and 15, the printed wiring board 20 is attached to the casting 68 with two screws 31 and 32 at positions that are near the top of the casting 68 and are separated from each other by a prescribed distance. As shown in FIG. 14, the contact portion 68f of the heat sink portion 68c is integral with and projects from the base portion 68e of the heat sink portion 68c. The contact portion 68f is inserted in the insertion portion 20a of the printed wiring board 20 and the insertion portion 19a of the terminal plate 19, and is in contact with the DMD 15 via the heat radiation sheet 22. With this structure, the heat radiation sheet 22 conducts heat from the DMD 15 to the contact portion 68f of the heat sink portion 68c.

Next, a method for adjusting the position of the printed wiring board 20 and the DMD 15 using the screws 31 and 32 will be described with reference to FIGS. 14 and 15. First, the screws 31 and 33 (see FIG. 7) are moved in a direction indicated by arrow J in FIG. 14 by tightening the screw 31 (see FIG. 15) and the screw 32 in the state of FIG. 14. During that course, the printed wiring board 20 and the DMD 15 are rotated in a direction indicated by arrow P in FIG. 14 with the link portion 68d of the casting 68 as a supporting point. In contrast, the screws 31 and 32 are moved in a direction indicated by arrow K in FIG. 10 by loosening them. During that course, the printed wiring board 20 and the DMD 15 are rotated in a direction indicated by arrow Q in FIG. 14 with the link portion 68d of the casting 68 as a supporting point. In this manner, a horizontal position adjustment (angle adjustment) of the printed wiring board 20 and the DMD 15 is enabled.

In the second embodiment, as described above, the printed wiring board 20 and the DMD 15 are mounted on the casting 68, the heat sink portion 68c for cooling the DMD 15 is connected to the bottom portion of the casting 68 and is thereby integral with the casting 68, and the printed wiring board 20 is attached to the casting 68 with the two screws 31 and 32 at the positions that are near the top of the casting 68 and are separated from each other by the prescribed distance. Therefore, even if an upper portion of the heat sink portion 68c which is connected to the bottom portion of the casting 68 and is thereby integral with the casting 68 is bent in the horizontal direction, the bend can be corrected for by the screws 31 and 32. Even in the case where the casting 68 and the heat sink portion 68c are integral with each other, a vertical position adjustment (angle adjustment) of the printed wiring board 20 that is mounted on the heat sink portion 68c can be performed in the above manner and hence a position adjustment (angle adjustment) of the DMD 15 that is mounted on the printed wiring board 20 can be performed. As a result, the dimensional accuracy required for the casting 68 which is involved in the positioning of the DMD 15 can be lowered, which facilitates the manufacture of the casting 68, which in turn makes it possible to increase the efficiency of manufacture of the casting 68 and lower its manufacturing cost. Further, since a position adjustment (angle adjustment) of the DMD 15 is performed by using at least two screws 31 and 32 for attaching, to the casting 68, the printed wiring board 20 that is mounted with the DMD 15, a position adjustment (angle adjustment) of the DMD 15 can be performed by a simple structure.

The embodiments disclosed this time should be construed as illustrative and not restrictive in all aspects. The scope of the invention is defined by the claims rather than the above embodiments, and encompasses all changes that fall within meets and bounds of the claims or equivalence of such meets and bounds.

For example, although in the above embodiments the DMD is used as the light modulation element, the invention is not limited to such a case and an element other than the DMD may be used as the light modulation element.

Although in the first embodiment the printed wiring board is attached to the casting with the four screws, the invention is not limited to such a case and the printed wiring board may be attached with three or less screws or five or more screws.

Although in the above embodiments the compression coil springs are interposed between the printed wiring board and the casting, the invention is not limited to such a case and the compression coil springs may be omitted. In this case, it is preferable to provide a member for urging the printed wiring board in the direction going away from the casting.

What is claimed is:

1. A projector comprising:
a light source lamp;
a projection lens for projecting an image;
a light modulation element for reflecting light radiated from the light source lamp and thereby supplying the light to the projection lens;
a printed wiring board for controlling the light modulation element mounted on the printed wiring board; and
an optical part holder mounted with the projection lens and the light modulation element,
wherein the printed wiring board is mounted on the optical part holder by at least four screw members which are arranged so as to surround the light modulation element,
the screw members are attached to the optical part holder via compression coil springs which are disposed between the printed wiring board and the optical part holder, and
the light modulation element is position-controlled by adjusting amounts of turning of the screw members.

2. A projector comprising:
a light source lamp;
a projection lens for projecting an image;
a light modulation element for reflecting light radiated from the light source lamp and thereby supplying the light to the projection lens;
a printed wiring board for controlling the light modulation element mounted on the printed wiring board; and
an optical part holder mounted with the projection lens and the light modulation element,
wherein the printed wiring board mounted with the light modulation element is mounted on the optical part holder by a screw member, and
the light modulation element is position-controlled by adjusting an amount of turning of the screw member.

3. The projector according to claim 2,
wherein the printed wiring board is mounted on the optical part holder by at least four screw members which are arranged so as to surround the light modulation element.

4. The projector according to claim 2,
wherein the printed wiring board and the light modulation element are mounted on the optical part holder,
a heat sink member for cooling the light modulation element is connected to a lower part of the optical part holder and is thereby integral with the optical part holder, and
the printed wiring board is mounted on the optical part holder by at least two screw members at positions that are on an upper part of the optical part holder and are separated from each other by a predetermined distance.

5. The projector according to claim 2,
wherein the screw member is attached to the optical part holder via a compression coil spring which is disposed between the printed wiring board and the optical part holder.
